(19) United States
(12) Patent Application Publication
(10) Pub. No.: US 2003/0018525 A1
(43) Pub. Date: Jan. 23, 2003

(54) Apparatus and method for providing compensation-based telemarketing information

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 10/032,459

(22) Filed: Jan. 2, 2002

Related U.S. Application Data
(60) Provisional application No. 60/260,795, filed on Jan. 9, 2001.

(51) Int. Cl. G06F 17/60; G09B 3/00; G09B 7/00

(52) U.S. Cl. 705/14; 705/10; 434/322

(57) ABSTRACT

An apparatus and method for providing compensation-based telemarketing information, including a memory device for storing at least one of individual information for at least one individual, individual contact information, telemarketer information, compensation information, reward information, and telemarketing subject matter, a processor for detecting telemarketing activity, wherein the processor records information regarding at least one of information provided to the individual, information obtained from the individual, and information regarding the telemarketing activity. The processor calculates or determines a compensation or a reward earned by the individual as compensation for the individual at least one of receiving, listening to, and participating in, the telemarketing activity.

### RELATED APPLICATIONS

This application claims the benefit of priority of U.S. Provisional Patent Application Serial No. 60/260,795, filed Jan. 9, 2001, and entitled “APPARATUS AND METHOD FOR PROVIDING COMPENSATION-BASED TELEMARKETING INFORMATION”, the subject matter of which is hereby incorporated by reference herein.

### FIELD OF THE INVENTION

The present invention pertains to an apparatus and method for providing compensation-based telemarketing information and, in particular, to an apparatus and method which provides compensation or rewards to individuals or entities in exchange for their attention to telemarketing telephone calls and/or telemarketing information, for their cooperation in receiving and/or listening to telemarketing telephone calls and/or telemarketing information, and/or for their participation in telemarketing activities and/or in telemarketing surveys or polling activities.

### BACKGROUND OF THE INVENTION

Telemarketing activities typically involve a telemarketer or telemarketing entity making unsolicited and/or unwelcome telephone calls to individuals or entities, at their home, or at work, in order to sell goods, products, services, or subscriptions, and/or in order to conduct surveys. These telemarketing activities facilitate the one-on-one communication between a telemarketer or agent of a respective marketer or information gathering entity and can be viewed as being an effective marketing or information gathering activity.

These telemarketing activities have been known to occur or to take place at various times of the day. People, however, generally do not appreciate, and many are outright offended by, the practices of telemarketers in making unsolicited and usually unwanted telephone calls to their homes, sometimes early in the morning, late at night, during dinner or meals, and/or at other unwelcome or inappropriate times.

Further, some telemarketers refuse to take “no” for an answer and make it difficult for the receiving party to end the telephone call. All in all, telemarketers and telemarketing activities have come to be viewed by many as a nuisance and as an invasion of privacy.

In recent times, some governmental subdivisions gone so far as to take steps in order to protect individuals from unwanted and/or unwelcome telemarketing calls. For example, an individual can place his or her telephone number on a “do not call” list. In this manner, individuals or entities can take steps in order to put an end to receiving these unwanted telemarketing telephone calls.

In the end, however, it is submitted that telemarketing activities can be a valuable marketing tool and/or information gathering tool. It is further submitted that individuals can also benefit from telemarketing activities.

Presently, no system, apparatus, or method, addresses the needs of both the telemarketers and the individuals or entities who or which are the targets of their respective telemarketing activities and information gathering activities.

### SUMMARY OF THE PRESENT INVENTION

The present invention pertains to an apparatus and method for providing compensation-based telemarketing information which overcomes the shortfalls of the prior art. The apparatus and method provides compensation or rewards to individuals or entities in exchange for their attention to telemarketing telephone calls and/or telemarketing information, for their cooperation in receiving and/or listening to telemarketing telephone calls and/or telemarketing information, and/or for their participation in telemarketing activities and/or in telemarketing surveys or polling activities.

The apparatus and method of the present invention can provide compensation to individuals or entities who or which consent to receive, listen to, and/or participate in, telemarketing calls, telemarketing-related surveys, and/or marketing campaigns, advertising campaigns, promotional campaigns, and/or surveys and/or polls, which are conducted via telephone, telecommunications, and/or other means.

The present invention can also provide for the targeting of telemarketing activities or campaigns to those individuals and/or entities who and/or which are interested in receiving and/or participating in same.

The present invention can also be utilized in order to allow individuals and/or entities to provide information regarding the types of telemarketing calls or communications which they will agree to accept and/or to participate in. The present invention can also be utilized in order to allow individuals and/or entities to provide information regarding the compensation which they desire in exchange for their attention and/or participation in the telemarketing calls or communications.

The present invention can also maintain voice mail accounts and/or voice mailboxes for individuals and/or entities. The present invention can also store telemarketing messages for individuals and/or entities who or which can thereafter retrieve the telemarketing messages.

The apparatus of the present invention includes a central processing computer which can perform any of the herein-described communications, telemarketing communications, processing routines and/or processing operations, for providing telemarketing activities, for performing the telemarketing communications, for providing telemarketing communications transmissions, and for providing compensation to individuals and/or entities for their receiving, listening to, and/or participating in, telemarketing calls, messages, and/or activities. The central processing computer can also be, or include, a telephone system which can be utilized in order to perform telephone calls and/or telemarketing calls as well as any of the herein-described processing routines.

The apparatus can also include one or more telemarketer computers which can be associated with one or more of the herein-described telemarketers and/or any merchants, marketers, advertisers, and/or survey takers, who or which utilize the present invention to engage in telemarketing activities.

The apparatus can also include one or more account administration computers which can administer any one or more of the financial accounts for any of the herein-described individuals, entities, and/or telemarketers.

The apparatus can also include one or more individual communication devices which can be associated with one or more of the herein-described individuals or entities.

The central processing computers, the telemarketer computers, the account administrator computers, and/or the individual communication devices, can communicate with, transmit information to, and/or receive information from, any other central processing computer(s), telemarketer computer(s), account administrator computer(s), and/or individual communication devices, over any suitable communication network or system.

The apparatus of the present invention can be utilized on, over, and/or in conjunction with, any suitable communication network or system, including, but not limited to a telephone network, a telecommunication network, a digital communication network, a satellite communication network, a wireless communication network, a personal communication services network, a broadband communication network, a bluetooth communication network, the Internet, the World Wide Web, and/or any other communication network and/or system.

Any of the telemarketing calls, messages, and/or activities, can include or involve audio information, video information, text information, and/or any combination of same. The information can be digitally-marked and/or encoded, and/or can be time-marked and/or encoded, in order to facilitate determining how much of the respective information has been provided to, or transmitted to, an individual or entity.

The present invention can be utilized in order to provide compensation-based telemarketing activities. The present invention can facilitate an individual and/or an entity registering with the central processing computer and/or with the operator of the central processing computer in order to signify his, her, or its, desire or willingness to receive telemarketing calls or telelmarketing messages, and/or to participate in telemarketing calls, surveys, or polls. The individual or entity can also select the specific telemarketing calls, messages, and/or activities, which he, she, or it, desires to receive, listen to, and/or participate in.

The present invention can identify the individual or entity to whom it desires to make the telemarketing call, place the telephone call, detect the call being made, and/or detect whether the call is answered. The present invention can provide the telemarketing call or message to the individual. The telemarketing call or message can be a live message from a telemarketer or a telemarketer's employee or agent or can be a pre-recorded message and/or can be a combination of both.

The present invention can obtain information and/or feedback from the individual. The present invention can also record information regarding the telemarketing call and compute the compensation earned by the individual. The present invention can also provide the individual with the individual's earned compensation, or indicia of the earned compensation.

The compensation can be provided to the individual in any appropriate manner.

The present invention can also update the accounts of any of the individuals, entities, and/or telemarketers or other parties who or which utilize the present invention.

The present invention can also record and/or store any information regarding any telemarketing calls or activities.

The present invention can also be utilized in order to allow a telemarketer to identify a group or audience of individuals and/or entities to which telemarketing calls can be directed.

The present invention can also be utilized in order to record telemarketing calls or messages as voice mail messages for an individual or entity. The present invention can also provide and/or facilitate the storage of voice messages in a voice mail box which can be assigned to, and/or associated with an individual or entity. The present invention can detect and monitor an individual's or an entity's retrieval of, receipt of, listening to, and/or participation in, any of the stored voice mail messages. The present invention can also compute the compensation earned by the individual or entity for retrieving, receiving, listening to, and/or participating in, the recorded telemarketing messages. The present invention can also provide the earned compensation to the individual or entity.

The present invention can also provide notification to any of the herein-described individuals and/or entities, of the existence of and/or of the availability of a telemarketing call, telemarketing calls, a telemarketing message, telemarketing messages, and/or a telemarketing activity or telemarketing activities, for which compensation and/or a reward is being offered.

The present invention can also provide notification to telemarketers, merchants, vendors, providers, advertisers, and/or promoters, of the existence of and/or of the willingness of individuals or entities to receive, to listen to, and/or to participate in, a telemarketing call, telemarketing calls, a telemarketing message, telemarketing messages, and/or a telemarketing activity or telemarketing activities, for which compensation and/or a reward is being offered.

The present invention can also be utilize, and/or can be utilized in conjunction with intelligent agents, software agents, mobile agents, and/or related technologies, which can be programmed and/or designed to act on behalf of any of the respective individuals, entities, telemarketers, merchants, vendors, providers, advertisers, and/or promoters, who or which utilize the present invention, and/or to perform any of the processing routines or functionality described herein as being performed by the present invention.

The present invention can also be self-activating and/or activated automatically.

The present invention can also administer and/or maintain a financial account(s) for, or on behalf of, any of the herein-described and/or herein-defined individuals, entities, telemarketers, merchants, vendors, providers, advertisers, and/or promoters, who or which utilize the apparatus and method of the present invention.

The present invention can also effect financial and/or non-financial transactions and/or transfers, make a financial and/or non-financial payment on behalf of, and/or receive a financial and/or non-financial payment, for or on behalf of, any of individuals, entities, telemarketers, merchants, vendors, providers, advertisers, and/or promoters, who or which utilize the present invention.

The present invention can provide an incentive for individuals or entities to receive, to listen to, and/or to participate in, telemarketing calls, messages, surveys, polls, and/or other activities.

The present invention can also provide for an efficient and/or more effective targeting and/or disseminating of telemarketing calls, messages, and/or activities, to individuals, entities, and/or audiences of same.

Accordingly, it is an object of the present invention to provide an apparatus and method for providing compensation-based telemarketing information.

It is another object of the present invention to provide an apparatus and method for providing compensation-based telemarketing information which provides compensation or rewards to individuals or entities in exchange for their attention to telemarketing telephone calls and/or telemarketing information.

It is still another object of the present invention to provide an apparatus and method for providing compensation-based telemarketing information which provides compensation or rewards to individuals or entities in exchange for their cooperation in receiving and/or listening to telemarketing telephone calls, messages, and/or telemarketing information.

It is yet another object of the present invention to provide an apparatus and method for providing compensation-based telemarketing information which provides compensation or rewards to individuals or entities in exchange for their participation in telemarketing call, activities, and/or in telemarketing surveys or polling activities.

It is another object of the present invention to provide an apparatus and method for providing compensation-based telemarketing information which provides compensation or rewards to individuals or entities who or which consent to receive, listen to, and/or participate in, telemarketing calls, telemarketing messages, telemarketing-related surveys, and/or marketing campaigns, advertising campaigns, promotional campaigns, and/or surveys and/or polls.

It is still another object of the present invention to provide an apparatus and method for providing compensation-based telemarketing information which can provide for the targeting of telemarketing activities or campaigns to those individuals and/or entities who and/or which are interested in receiving and/or participating in same.

It is yet another object of the present invention to provide an apparatus and method for providing compensation-based telemarketing information which can be utilized in order to allow individuals and/or entities to provide information regarding the types of telemarketing calls or communications in which they will agree to accept and/or to participate.

It is another object of the present invention to provide an apparatus and method for providing compensation-based telemarketing information which can allow an individual to provide information regarding the compensation which the individual desires to receive in exchange for his, her, or its, attention and/or participation in telemarketing calls or communications.

It is still another object of the present invention to provide an apparatus and method for providing compensation-based telemarketing information which can maintain voice mail accounts and/or voice mailboxes for individuals and/or entities.

It is yet another object of the present invention to provide an apparatus and method for providing compensation-based telemarketing information which can record or store telemarketing messages for individuals and/or entities.

It is another object of the present invention to provide an apparatus and method for providing compensation-based telemarketing information which can provide for an individual's retrieval of stored telemarketing messages from a voice mailbox.

It is still another object of the present invention to provide an apparatus and method for providing compensation-based telemarketing information which can be utilized on, over, and/or in conjunction with, any suitable communication network or system.

It is yet another object of the present invention to provide an apparatus and method for providing compensation-based telemarketing information which can be utilized on, over, and/or in conjunction with, a telephone network and/or a telecommunications network.

It is another object of the present invention to provide an apparatus and method for providing compensation-based telemarketing information which can be utilized on, over, and/or in conjunction with, a wireless telephone network and/or a wireless telecommunications network.

It is still another object of the present invention to provide an apparatus and method for providing compensation-based telemarketing information which can be utilized on, over, and/or in conjunction with, the Internet and/or the World Wide Web.

It is yet another object of the present invention to provide an apparatus and method for providing compensation-based telemarketing information which can be utilized on, over, and/or in conjunction with, any one or more of a telephone network, a telecommunication network, a digital communication network, a satellite communication network, a wireless communication network, a personal communication services network, a broadband communication network, a bluetooth communication network, the Internet, and/or the World Wide Web.

It is another object of the present invention to provide an apparatus and method for providing compensation-based telemarketing information which can provide audio information.

It is still another object of the present invention to provide an apparatus and method for providing compensation-based telemarketing information which can provide video information.

It is yet another object of the present invention to provide an apparatus and method for providing compensation-based telemarketing information which can provide text information.

It is another object of the present invention to provide an apparatus and method for providing compensation-based telemarketing information which can provide any one or more of text information, audio information, video information, and/or audio and video information.

It is still another object of the present invention to provide an apparatus and method for providing compensation-based telemarketing information which can allow an individual to select the telemarketing calls, messages, activities, surveys, and/or polls, which he or she desires to receive, listen to, and/or in which to participate.

It is yet another object of the present invention to provide an apparatus and method for providing compensation-based telemarketing information which can allow an individual to dictate the compensation or reward which the individual desires to receive in exchange for receiving, listening to, and/or participating in, telemarketing calls, messages, activities, surveys, and/or polls.

It is another object of the present invention to provide an apparatus and method for providing compensation-based telemarketing information which can identify an individual or entity to whom to target and/or to make a respective telemarketing call, to direct a telemarketing message, and/or to direct a telemarketing activity.

It is still another object of the present invention to provide an apparatus and method for providing compensation-based telemarketing information which can place or make a telemarketing telephone call.

It is yet another object of the present invention to provide an apparatus and method for providing compensation-based telemarketing information which can detect a telemarketing call being made or placed.

It is another object of the present invention to provide an apparatus and method for providing compensation-based telemarketing information which can detect whether a telemarketing call is answered.

It is still another object of the present invention to provide an apparatus and method for providing compensation-based telemarketing information which can provide a telemarketing call or message to an individual.

It is yet another object of the present invention to provide an apparatus and method for providing compensation-based telemarketing information which can provide a live telemarketing call or message.

It is another object of the present invention to provide an apparatus and method for providing compensation-based telemarketing information which can provide a recorded or pre-recorder telemarketing call or message.

It is still another object of the present invention to provide an apparatus and method for providing compensation-based telemarketing information which can provide a telemarketing call or message which can contain a combination of live information and pre-recorded information.

It is yet another object of the present invention to provide an apparatus and method for providing compensation-based telemarketing information which can obtain information and/or feedback from an individual.

It is another object of the present invention to provide an apparatus and method for providing compensation-based telemarketing information which can record information regarding the telemarketing call, message, or activity.

It is still another object of the present invention to provide an apparatus and method for providing compensation-based telemarketing information which can store information regarding the telemarketing call, message, or activity.

It is yet another object of the present invention to provide an apparatus and method for providing compensation-based telemarketing information which can compute compensation earned by an individual.

It is another object of the present invention to provide an apparatus and method for providing compensation-based telemarketing information which can determine a reward earned by an individual.

It is still another object of the present invention to provide an apparatus and method for providing compensation-based telemarketing information which can provide compensation to an individual.

It is yet another object of the present invention to provide an apparatus and method for providing compensation-based telemarketing information which can provide a reward to an individual.

It is another object of the present invention to provide an apparatus and method for providing compensation-based telemarketing information which can provide an individual with information regarding compensation which is earned by the individual.

It is still another object of the present invention to provide an apparatus and method for providing compensation-based telemarketing information which can provide an individual with information regarding a reward(s) which is earned by the individual.

It is yet another object of the present invention to provide an apparatus and method for providing compensation-based telemarketing information which can update an account of any individual, entity, telemarketer, or other party who or which utilizes the present invention.

It is another object of the present invention to provide an apparatus and method for providing compensation-based telemarketing information which can record information regarding telemarketing calls.

It is still another object of the present invention to provide an apparatus and method for providing compensation-based telemarketing information which can record information regarding telemarketing messages.

It is yet another object of the present invention to provide an apparatus and method for providing compensation-based telemarketing information which can record information regarding telemarketing activities.

It is another object of the present invention to provide an apparatus and method for providing compensation-based telemarketing information which can record information regarding telemarketing surveys or polls.

It is still another object of the present invention to provide an apparatus and method for providing compensation-based telemarketing information which can identify an individual, an entity, or a group or audience of individuals or entities, to which telemarketing calls, messages, activities, surveys, or polls, can be directed.

It is yet another object of the present invention to provide an apparatus and method for providing compensation-based telemarketing information which can record telemarketing calls or messages as voice mail messages for an individual or entity.

It is another object of the present invention to provide an apparatus and method for providing compensation-based telemarketing information which can store telemarketing calls or messages as voice mail messages for an individual or entity.

It is still another object of the present invention to provide an apparatus and method for providing compensation-based telemarketing information which can maintain voice mailboxes for an individual or entity.

It is yet another object of the present invention to provide an apparatus and method for providing compensation-based telemarketing information which can detect and/or monitor an individual's or an entity's retrieval of telemarketing messages.

It is another object of the present invention to provide an apparatus and method for providing compensation-based telemarketing information which can record or store information regarding an individual's receipt of, listening to, or participation in, stored telemarketing messages.

It is still another object of the present invention to provide an apparatus and method for providing compensation-based telemarketing information which can compute compensation for, or determine a reward for, an individual's receipt of, listening to, or participation in, stored telemarketing messages.

It is yet another object of the present invention to provide an apparatus and method for providing compensation-based telemarketing information which can provide compensation to, or provide a reward to, an individual's for the individual's receipt of, listening to, or participation in, stored telemarketing messages.

It is another object of the present invention to provide an apparatus and method for providing compensation-based telemarketing information which can provide notification to an individual or entity, regarding the existence of or the availability of a telemarketing call, a telemarketing message, or a telemarketing activity for which compensation and/or a reward is being offered.

It is still another object of the present invention to provide an apparatus and method for providing compensation-based telemarketing information which can provide notification to a telemarketer of the existence of or of the willingness of an individual or entity to receive, to listen to, and/or to participate in, a telemarketing call, a telemarketing message, or a telemarketing activity, for compensation or for a reward.

It is yet another object of the present invention to provide an apparatus and method for providing compensation-based telemarketing information which can utilize or which can be utilized in conjunction with intelligent agents, software agents, or mobile agents.

It is another object of the present invention to provide an apparatus and method for providing compensation-based telemarketing information which can programmed to be self-activating or activated automatically.

It is still another object of the present invention to provide an apparatus and method for providing compensation-based telemarketing information which can administer or maintain a financial account(s) for, or on behalf of, an individual, an entity, or a telemarketer, who or which utilizes the present invention.

It is yet another object of the present invention to provide an apparatus and method for providing compensation-based telemarketing information which can effect a financial or a non-financial transaction, for, or on behalf of, an individual, an entity, or a telemarketer, who or which utilizes the present invention.

It is another object of the present invention to provide an apparatus and method for providing compensation-based telemarketing information which can receive a financial and/or non-financial payment, for, or on behalf of, an individual, an entity, or a telemarketer, who or which utilizes the present invention.

It is still another object of the present invention to provide an apparatus and method for providing compensation-based telemarketing information which can make a financial and/or non-financial payment, for, or on behalf of, an individual, an entity, or a telemarketer, who or which utilizes the present invention.

It is yet another object of the present invention to provide an apparatus and method for providing compensation-based telemarketing information which can provide an incentive for an individuals or an entity to receive, to listen to, and/or to participate in, a telemarketing call, message, activity, survey, or poll.

It is another object of the present invention to provide an apparatus and method for providing compensation-based telemarketing information which can provide an efficient and/or a more effective targeting or dissemination of a telemarketing call, message, or activity, to an individual, an entity, or an audience of same.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central processing computer of FIG. 1, in block diagram form;

FIG. 3 illustrates a preferred embodiment method for utilizing the apparatus of FIG. 1, in flow diagram form;

FIG. 4 illustrates another preferred embodiment method for utilizing the apparatus of FIG. 1, in flow diagram form; and

FIG. 5 illustrates another preferred embodiment method for utilizing the apparatus of FIG. 1, in flow diagram form.

### DESCRIPTION OF THE PREFERRED EMBODIMENTS

The present invention pertains to an apparatus and method for providing compensation-based telemarketing information and, in particular, to an apparatus and method which provides compensation or rewards to individuals or entities in exchange for their attention to telemarketing telephone calls and/or telemarketing information, for their cooperation in receiving and/or listening to telemarketing telephone calls and/or telemarketing information, and/or for their participation in, telemarketing calls, messages, activities, and/or in telemarketing surveys or polling activities.

The apparatus and method of the present invention can provide compensation to individuals or entities who or which consent to receive, listen to, and/or participate in, telemarketing calls, telemarketing messages, telemarketing-related surveys, and/or marketing campaigns, advertising campaigns, promotional campaigns, and/or surveys and/or polls, which are conducted via telephone, telecommunications, and/or other means.

The apparatus and method of the present invention can also provide for the targeting of telemarketing activities or campaigns to those individuals and/or entities who and/or which are interested in receiving and/or participating in same.

The apparatus and method of the present invention can also be utilized in order to allow individuals and/or entities to provide information regarding the types of telemarketing calls or communications which they will agree to accept and/or in which they will agree to participate. The apparatus and method of the present invention can also be utilized in order to allow individuals and/or entities to provide information regarding the compensation which they desire in exchange for their attention and/or participation in the telemarketing calls or communications.

The apparatus and the present invention can also maintain voice mail accounts and/or voice mailboxes for individuals and/or entities. The apparatus and method of the present invention can store telemarketing messages for individuals and/or entities who or which can thereafter retrieve the telemarketing messages.

As described herein, the term “compensation” refers to any cash compensation, monetary compensation, non-cash compensation, non-monetary compensation, coupon(s), discount coupon(s), rebate(s), rebate coupon(s), special offering(s), and/or any goods, products, services, and/or subscriptions for goods, products, and/or services, and/or any other type or kind of compensation or reward(s). The term compensation can also include any other compensation and/or compensatory entity which can be utilized to provide an incentive to an individual or entity to receive, listen to, and/or in which to participate, any of the telemarketing calls, messages, and/or activities, which can be offered by and/or which can be engaged in by telemarketers.

As described herein, the term “telemarketing activity”, “telemarketing call”, “telemarketing communication”, “telemarketing survey”, “telemarketing poll”, or the plural of same, refers to any telemarketing activities, calls, communications, surveys and/or polls, which can be conducted by telemarketers or telemarketing entities.

As defined herein, the terms “telemarketer” or the plural of same, refers to any individual, entity, organization who or which conducts and/or engages in telemarketing activities, telemarketing marketing, advertising, and/or promotional activities, and/or surveys or polls, conducted via telephone communications, telecommunication communications, computer communications, and/or network communications.

As defined herein, the terms “individual”, “entity”, “target individual”, “target entity”, “telemarketing audience”, or the plurals of same, refers to any of the respective individuals, entities, target individuals, target entities, and/or target audiences, who or which receive, listen to, and/or in which to participate, any of the herein described telemarketing activities.

As used herein, the term “account” or the plural of same, refers to any telemarketing compensation account(s), telemarketing participation account(s), telemarketing information dissemination account(s), telemarketing information gathering account(s), and/or any financial account(s), associated with and/or corresponding to any of the herein described individuals, entities, and/or telemarketers, described herein.

As used herein, the terms “operator”, “administrator”, or the plural of same, refer to any operator or administrator who or which operates and/or administers the operation of the apparatus of the present invention.

As used herein, the terms “telemarketer”, “merchant”, “provider”, “vendor”, “marketer”, “telemarketing entity”, “advertiser”, “advertising entity”, “promoter”, “promoting entity”, and/or the plural of same, refers to any telemarketer, merchant, provider, vendor, marketer, telemarketing entity, advertiser, advertising individual or entity, promoter, and/or promoting individual or entity, who or which provides, or causes to be provided or disseminated, any of the herein-described telemarketing materials and/or information, advertisement materials and/or information, and/or promotional materials and/or information, and/or any of the goods, products, services, and/or subscriptions which may be the subject any of the herein-described telemarketing, advertising, and/or promotional, materials and/or information. A merchant, vendor, provider, advertiser, or promoter, can also act as its own telemarketer.

Applicant hereby incorporates by reference herein the subject matter and teachings of U.S. Provisional Patent Application Serial No. 60/260,795 which teaches and discloses an apparatus and method for providing compensation-based telemarketing information.

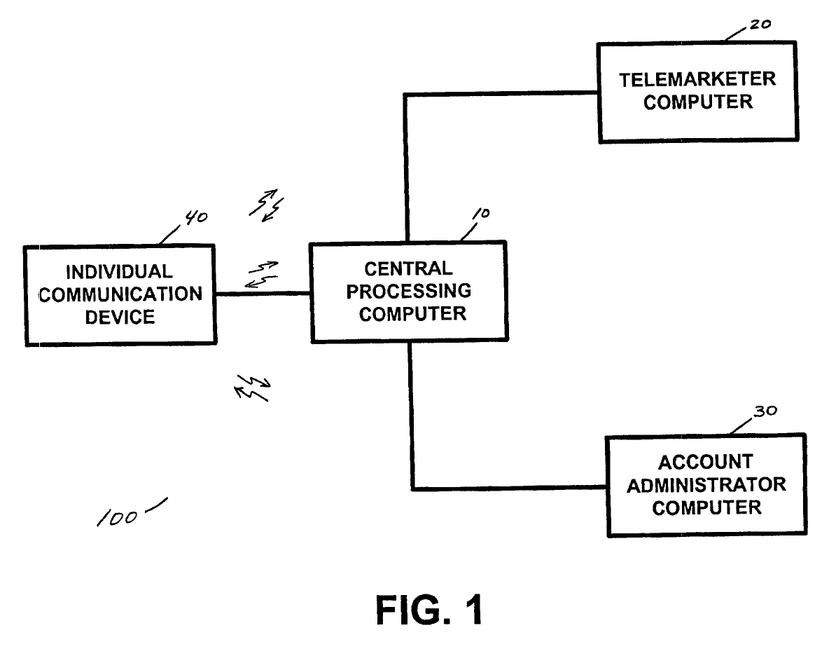

FIG. 1 illustrates a preferred embodiment of the apparatus of the present invention which is designated generally by the reference numeral 100, in block diagram form. With reference to FIG. 1, the apparatus 100 includes a central processing computer 10.

The central processing computer 10 can perform any of the herein-described communications, telemarketing communications, processing routines and/or processing operations, for providing telemarketing activities, for performing the telemarketing communications, for providing telemarketing communications transmissions, and for providing compensation to individuals and/or entities for their receiving, listening to, and/or participating in, telemarketing activities. For example, in the preferred embodiment, the central processing computer 10 can be, or can include, a computerized telephone or computerized telephone system which can perform computerized telephone calls and/or telemarketing calls.

The central processing computer 10, in the preferred embodiment, can also be, and/or include, a telephone system which can be utilized in order to perform telephone calls and/or telemarketing calls as well as any of the processing routines described herein as being performed by the apparatus 100 and/or the central processing computer 10.

In the preferred embodiment, the central processing computer 10 can also include or be linked with any telephone, telephone system, or computerized telephone system, and/or a telecommunications device, for allowing the central processing computer 10 to make, to control, to monitor, and/or to process information relating to, telephone calls and/or telemarketing telephone calls, and/or for performing any of the telemarketing communications and/or activities described herein.

The telephone calls, telemarketing calls, and/or telemarketing communications and/or activities, performed and/or provided by the central processing computer 10 and/or the apparatus 100 can involve and/or include live telephone calls, communications, and/or activities, pre-recorded telephone calls, communications, and/or activities, and/or any combination of same.

The central processing computer 10 can provide or perform telephone calls, communications, and/or activities, live and/or pre-recorded, which can include audio information, video information, test information, audio and video information, and/or any combination of same.

The central processing computer 10 can also provide any of the other information described herein as being provided by the apparatus 100 and/or perform any of the processing routines described herein as being performed by the apparatus 100.

The central processing computer 10 can be a computer, a computer system, and/or a network computer, which can be a telephone services provider computer, a telecommunications services provider computer, a telemarketer computer, and/or a computer for providing any of the herein-described processing routines and/or functionality for any telemarketer or group of telemarketers.

The central processing computer 10 can service any number of the herein-described telemarketers, individuals, and/or entities, and/or any of the accounts associated therewith and/or corresponding thereto. The central processing computer 10 can include any number of central processing computers. Any number of central processing computers 10 can be utilized in conjunction with the apparatus 100.

The central processing computer 10 can be any computer, computer system, network computer, server computer, and/or communication device.

With reference once again to FIG. 1, the apparatus 100 can also include one or more telemarketer computers 20 which can be associated with one or more of the herein-described telemarketers and/or any merchants, marketers, advertisers, and/or survey takers, who or which utilize the apparatus 100 to engage in telemarketing activities.

The telemarketer computer 20 can transmit information to as well as receive information from the central processing computer(s) 10.

The telemarketer computer 20 can be any one or more a computer, a computer system, a group of computers, a telephone, a personal computer, a wireless telephone, a personal digital assistant, a video telephone, a personal communication device, a wireless device, a handheld device, a palm-top device, and/or any other communication device(s) and/or computer(s).

With reference once again to FIG. 1, the apparatus 100 can also include one or more account administration computers 30 which can administer any one or more of the financial accounts for any of the herein-described individuals, entities, and/or telemarketers. The account administration computer 30 can be integrated with, can be an integrated component of, can be linked to, and/or can be associated with, the central processing computer(s) 10.

The account administrator computer can also be associated with a telephone services provider, a telecommunications services provider, and/or a financial institution, a bank, and/or any other suitable entity.

The account administration computer 30 can transmit information to as well as receive information from the central processing computer(s) 10.

The account administration computer 30 can be any one or more a computer, a computer system, and/or a group of computers.

With reference once again to FIG. 1, the apparatus 100 also includes one or more individual communication devices 40 which can be associated with one or more of the herein-described individuals or entities. The individual communication device 40 can transmit information to as well as receive information from the central processing computer(s) 10.

The user communication device 40 can be any one or more a telephone, a telephone answering machine, a voice mailbox, a computer, a computer system, a group of computers, a personal computer, a wireless telephone, a personal digital assistant, a video telephone, a personal communication device, a wireless device, a handheld device, a palm-top device, and/or any other communication device(s) and/or computer(s). In the simplest instance, the individual communication device 40 can be a telephone for allowing an individual to receive telemarketing telephone calls. The telephone may or may not have an answering machine associated therewith and/or connected thereto for recording telemarketing messages.

Any number of central processing computers 10, the telemarketer computers 20, account administrator computers 30, and/or individual communication devices 40, can be utilized in conjunction with the present invention.

The central processing computers 10, the telemarketer computers 20, the account administrator computers 30, and/or the individual communication devices 40, can communicate with, transmit information to, and/or receive information from, any other central processing computers 10, telemarketer computers 20, account administrator computers 30, and/or individual communication devices 40, over any suitable communication network or system, including, but not limited to a telephone network, a telecommunication network, a digital communication network, a satellite communication network, a wireless communication network, a personal communication services network, a broadband communication network, a bluetooth communication network, the Internet, the World Wide Web, and/or any other communication network and/or system.

The apparatus 100 can be utilized on, over, and/or in conjunction with, any suitable communication network or system, including, but not limited to a telephone network, a telecommunication network, a digital communication network, a satellite communication network, a wireless communication network, a personal communication services network, a broadband communication network, a bluetooth communication network, the Internet, the World Wide Web, and/or any other communication network and/or system.

Any of the central processing computers 10, the telemarketer computers 20, the account administrator computers 30, and/or the individual communication devices 40, can include, where appropriate and/or where suitable, a central processing unit (CPU), a random access memory (RAM), a read only memory (ROM), an input device, a display device, a receiver, a transmitter, a database, and an output device.

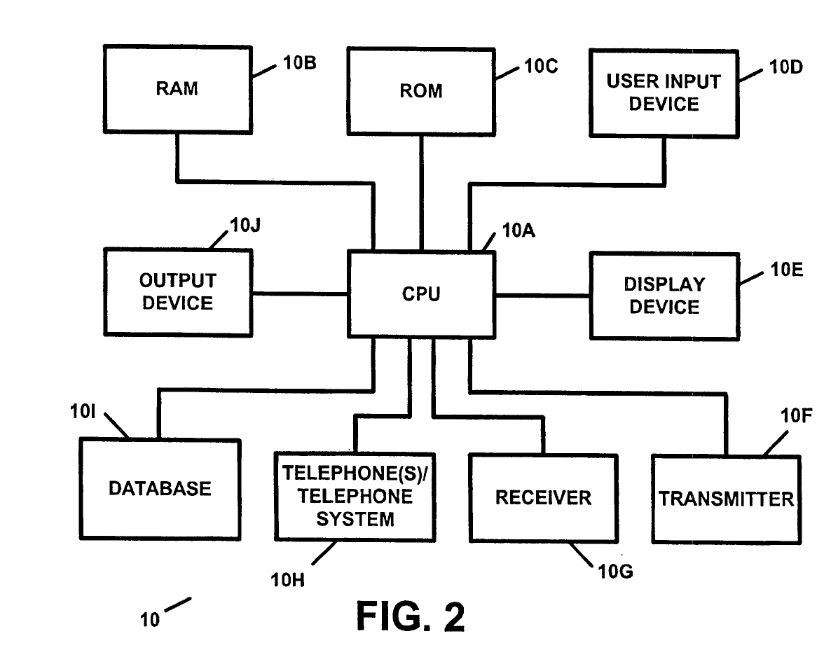

FIG. 2 illustrates the central processing computer 10 of FIG. 1, in block diagram form. With reference to FIG. 2, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory devices(s) 10C (ROM), each of which is connected to the CPU 10A, a user input device 10D, for entering data and/or commands into the central processing computer 10, which includes any one or more of a keyboard, a scanner, a user pointing device, such as, for example, a mouse, a touch pad, and/or an audio input device and/or a video input device, etc., if desired, which input device(s) is also connected to the CPU 10A. The central processing computer 10 also includes a display device 10E for displaying data and/or information to a user or operator.

The central processing computer 10 also includes a transmitter(s) 10F, for transmitting signals and/or data and/or information to any one or more of the central processing computers 10, the telemarketer computers 20, the account administrator computers 30, and/or the individual communication devices 40, which may be utilized in conjunction with the present invention.

The central processing computer 10 also includes a receiver 10G, for receiving signals and/or data and/or information from any one or more of the central processing computer(s) 10, the telemarketer computers 20, the account administrator computers 30, and/or the individual communication devices 40, which may be utilized in conjunction with the present invention.

The central processing computer 10 also includes any number of telephones, computerized telephones, or a telephone system 10H (hereinafter referred to as “telephone 10H”, “telephones 10H”, or “computerized telephones 10H”). The telephones, or computerized telephones 10H can be utilized in order to facilitate to making of manual and/or live telephone telemarketing calls by telemarketers, their employees and/or representative and/or any other individuals, operators, or entities. The telephones or computerized telephones 10H can be utilized in order to facilitate to making of automated telephone telemarketing calls by the central processing computer 10, and/or by telemarketers, their employees, representative and/or by any other individuals, operators, or entities. The automated telephone telemarketing calls can be pre-recorded calls or pre-recorded messages. The telephone(s) or computerized telephone(s) 10H can be utilized in order to provide live telemarketing messages, pre-recorded messages, and/or can leave messages on the individual communication devices 40 and/or on answering machines connected therewith and/or associated therewith.

In this manner, the central processing computer 10 can be utilized in order to facilitate the making of telephone telemarketing calls and/or performing the communications associated with performing any of the telemarketing activities described herein.

The central processing computer 10 can control the telephones or computerized telephones 10H, and can control the selection of telephone numbers, can control the directory looking-up of telephone numbers, can control the activation or initiation of a telephone telemarketing call, can control the dialing of a telephone telemarketing call, can perform the detection of a telephone telemarketing call connection, can monitor and/or record the time or duration of the call, and/or the amount of the message and/or the amount of a telephone telemarketing message received by, listened to, and/or participated in, by the individual or entity receiving same.

The central processing computer 10 and/or the telephone(s) and/or the computerized telephone(s) 10H can receive, record, and/or process, any information provided by the individual or entity which can be voice or audio information and/or digital information which can be generated by dial pad or keypad entries on the individual computer or telephone 40.

The central processing computer 10 can also process information regarding attempted telemarketing calls, completed telemarketing calls, telemarketing call messages left on an answering machine, and/or telemarketing calls which may be re-attempted at a later time.

With reference to FIG. 2, the central processing computer 10 also includes a database 10. The database 10I can contain any data, information, software programs, software algorithms, and/or any other information needed and/or desired for performing any of the processing routines and/or functionality described herein as being performed by the central processing computer(s) 10 and/or by the apparatus 100.

The database 10I can also include any data and/or information needed and/or desired for performing any of the processing routines and/or functionality described herein as being performed by any of the telemarketer computers 20, the account administrator computers 30, and/or the individual communication devices 40, described herein.

The database 10I can contain data and/or information regarding any of the individuals, entities, telemarketers, and/or other parties or entities who or which are serviced by the apparatus 100. The database 10I can also contain account information, account number information, account identification information and any other pertinent or relevant account information for any of the individuals, entities, telemarketers, and/or other parties or entities who or which are serviced by the apparatus 100.

The database 10I can also contain contact and/or correspondence information for any of the individuals, entities, who or which are serviced by the apparatus 100. The contact information can include, but is not limited to, name(s), address or addresses, mailing address or mailing addresses, telephone number(s), facsimile number(s), e-mail address or e-mail addresses, uniform resource locator (url) or urls, contact information, and/or contact name(s).

The database 10I can also contain data and/or information regarding the type or kind of telemarketing telephone calls which the individual or entity is desirous or willing to receive, to listen to, and/or in which to participate. The database 10I can also contain data and/or information regarding the type or kind of telemarketing or other surveys or polls which the individual or entity is desirous or willing to receive, to listen to, and/or in which to participate.

The database 10I can also contain data and/or information regarding the conditions under which the individual or entity is willing to receive, to listen to, and/or in which to participate. The database 10I can also contain individual or entity dictated types of telemarketing calls he, she, or it, is willing to receive, the type of, and amount of, compensation which the individual or entity requires, and the mode or manner of payment of same, in exchange for and/or in order for the individual or entity to agree to receive, to listen to, and/or in which to participate, telemarketing messages, activities, surveys, or polls.

The database 10I can also contain data and/or information regarding restriction and/or limitations on the times, days, types, kinds, or amount of, telemarketing messages, activities, surveys, or polls, which the individual or entity will agree to receive, to listen to, and/or to in which to participate. For example, an individual can specify the times or days of telemarketing messages, activities, surveys, or polls (i.e. specific time periods, all day, no calls after 8:00 PM, no calls of weekdays, no calls on Sunday, etc.), the type or kind of telemarketing messages, activities, surveys, or polls (i.e. goods, products, services, specific issue surveys, live calls, pre-recorded calls, audio messages, video message, calls providing a minimum amount of compensation (e.g. $0.50/minute, etc.)), the amount of telemarketing messages, activities, surveys, or polls which the user is willing to receive, to listen to, and/or in which to participate (i.e. one (1) hour per week, no more than fifteen (15) minutes per day, etc.

The database 10I can also contain information regarding how the individual or entity desires to be compensated (i.e. cash payment, check payment, automatic funds deposit into a bank account, automatic credit towards a purchase made during a telephone call, credit towards a telephone or other utility bill, etc.).

The database 10I can also include individual or entity account information, subscription account information and/or financial account information. The database 10I can also contain information regarding the amount of compensation or rewards earned by the individuals or entities who or which are serviced by the apparatus 100.

The database 10I can also contain data and/or information regarding any of the telemarketers, merchants, advertisers, survey takers, or other parties or entities who or which are serviced by the apparatus 100. The database 10I can also contain account information, account number information, account identification information and any other pertinent or relevant account information for any of the telemarketers and/or any of the other above-described parties or entities who or which are serviced by and/or who or which utilize the apparatus 100.

The database 10I can also contain contact and/or correspondence information for any of the telemarketers or other above-described parties or entities, who or which are serviced by, or who or which utilize, the apparatus 100. The contact information can include, but is not limited to, name(s), address or addresses, mailing address or mailing addresses, telephone number(s), facsimile number(s), e-mail address or e-mail addresses, uniform resource locator (URL) or URLs, contact information, and/or contact name(s).

The database 10I can also contain data and/or information regarding the type or kind of telemarketing telephone messages, materials, calls, or activities, which are provided by and/or engaged in by the respective telemarketers or other above-described parties or entities (hereinafter referred to “telemarketer”).

The database 10I can also contain the various telemarketing calls, messages and/or activities, which are offered and/or which are provided by the respective telemarketers (i.e. utility service offerings, retail offerings, etc.), a description of the various telemarketing calls, messages and/or activities, which are offered and/or which are provided by the respective telemarketers (i.e. offering description, background information, comments from satisfied customers), and/or the type of, and the amount of, compensation paid by the respective telemarketers for an individual's or an entity's receiving of, listening to, or participation in, any of the telemarketing calls, messages, and/or activities (i.e. payment amounts, cash payments, discount coupons, rebate coupons, etc.).

The database 10I can contain the types or kinds of telemarketing telephone messages, materials, calls, or activities, provided by the respective telemarketer (i.e. telephone calls, marketing of goods, products, services, advertising of goods, products, services, promotional of goods, products, services, political campaign materials, issue surveys, issue polling, live calls, pre-recorded messages, etc.), and/or information regarding the length of, and/or the degree of participation in the telemarketing telephone messages, materials, calls, or activities (i.e. five (5) minutes, answer questions, short answer responses, detailed responses, voice response, keypad or touch tone responses, subsequent calls, etc.).

The database 10I can also contain data and/or information regarding historical information regarding receipt histories or habits, listening histories or habits, and/or participation histories or habits, for any of the individuals or entities who or which utilize the apparatus 100 of the present invention.

The database 10I can also contain demographic data and/or information, economic data and/or information, econometric data and/or information, statistical data and/or information, and/or individual and/or entity profile data and/or information.

The database 10I can also contain data and/or information regarding schedules (i.e. times and dates, etc.) of offerings of telemarketing messages, calls, and/or activities, by the various telemarketers (i.e. retail offerings of Store A, Mondays 7:00 to 9:00, etc. and the compensation for agreeing to receive, to listen to, and/or to participate in, same (i.e. $1.00 cash payment, 15% discount coupon electronically sent via e-mail, etc.).

The database 10I can also contain pre-stored and/or pre-recorded telemarketing calls, messages, and/or materials, surveys and/or polling calls, messages, and/or materials, and/or any other telemarketer calls, messages, information and/or materials. For example, pre-recorded telemarketing message can be stored by a telemarketer for use or dissemination in computerized telephone telemarketing activities.

The database 10I can also contain data and/or information regarding individuals and/or entities who or which desire to receive telemarketing calls, and/or data and/or information regarding individuals or entities who or which desire to receive telemarketing calls from specific telemarketers, and/or individuals and/or entities who or which are targeted and/or who or which agree to be targeted to receive telemarketing calls or messages. The database 10I can also contain data and/or information regarding telephone numbers for any of the individuals who or which desire to receive telemarketing calls or messages from any of the various telemarketers who or which utilize the apparatus 100.

The database 10I can also contain data and/or information for calculating and/or computing the amount of compensation earned and/or rewards earned by an individual or entity. The database 10I can also contain data and/or information for storing the cumulative amount(s) of compensation earned and/or rewards earned by an individual or entity.

The database 10I can also contain data and/or information regarding financial accounts for any of the individuals, entities, telemarketers, merchants, providers, vendor, marketers, telemarketing entities, advertisers, promoters, and/or other individuals or entities who or which utilize the apparatus 100. The database 10I can also contain data and/or information for processing financial transactions and/or for administering any of the financial accounts described herein. The database 10I can also contain any data and/or information needed and/or desired for effecting the payment of, the delivery of, and/or the providing of, any of the compensation and/or rewards earned by any of the herein-described individuals or entities.

The database 10I can also contain information regarding how the respective telemarketers will provide compensation to an individual or entity (i.e. cash payment, check payment, automatic funds deposit into a bank account, automatic credit towards a purchase made during a telephone call, credit towards a telephone or other utility bill, etc.).

The database 10I can also contain data, information, software programs, and/or software algorithms, for generating and/or for producing any of the herein-described respective telemarketing materials or information.

The database 10I can also contain data and/or information for targeting, selecting, and/or scheduling, the dissemination of any of the respective telemarketing materials or information.

The database 10I can also contain data and/or information for performing monetary and/or financial transfers, electronically and/or otherwise, to and/or from any of the financial accounts associated with any of the herein-described users, individuals, entities, and/or telemarketers.

Any of the data and/or information described herein can be provided from multiple information sources and/or from multiple individuals or entities by utilizing any of the respective central processing computers 10, telemarketer computers 20, account administrator computers 30, and/or individual communication devices 40.

The database 10I can also contain any other information which may be relevant, pertinent, useful, and/or desired, for facilitating the operation of the apparatus and method of the present invention as described herein and/or as related thereto.

The database 10I, in the preferred embodiment, is a database which may include individual databases or collections of databases, with each database being designated to store any and all of the data and/or information described herein. Applicant hereby incorporates by reference herein the teachings of Basic Business Statistics Concepts and Applications, Mark L. Berenson and David M. Levine, 6^{th} Edition, Prentice Hall 1996.

The database 10I, or collection of databases, may be updated by each of the respective users, individuals, central processing computer operators or administrators, telemarketers, merchants, vendors, advertisers, promoters, described herein, and/or by any other individual, entity, or third party, in real-time and/or otherwise, and/or via dynamically linked database management techniques.

The data and/or information stored in the database 10I can also be updated by external sources. The database 10I will contain any and all information deemed necessary and/or desirable for providing all of the processing and/or services and/or functions described herein. Applicant hereby incorporates by reference herein the subject matter of Fundamentals of Database Systems, by Ramez Elmasri and Shamkant B. Navathe, 2^{nd} Ed., Addison-Wesley Publishing Company, 1994.

The database 10H can also include any other data and/or information needed and/or desired for facilitating the functions and operation of the present invention as described herein.

With reference once again to FIG. 2, the central processing computer 10 also includes an output device 10J such as a printer, a modem, a fax/modem, or other output device, for outputting information to the operator or user of the central processing computer 10 or to a third party or third party entity.

Any pre-recorded messages, including messages which can include audio information, video information, and/or text information, can be digitally-marked and/or encoded, and/or time-marked and/or encoded, in order to facilitate determining and/or ascertaining how much of the respective information has been provided to, or transmitted to, the individual. Applicant hereby incorporates by reference herein the subject matter and teachings of U.S. patent application Ser. No. 08/788,387, filed Jan. 27, 1997, which teaches an apparatus and method for providing educational materials and/or related services in a network environment. Applicant also hereby incorporates by reference herein the subject matter and teachings of U.S. Pat. No. 5,969,714 which teaches and discloses an interactive video system with frame reference number.

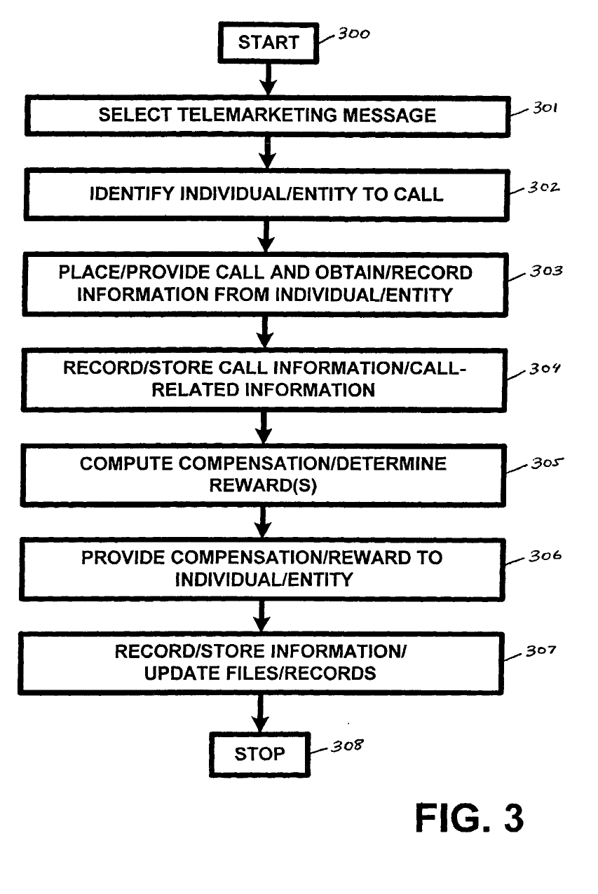

In a preferred embodiment, the apparatus 100 and method of the present invention can be utilized in order to provide compensation-based telemarketing activities. FIG. 3 illustrates a preferred embodiment method for utilizing the apparatus 100 of FIG. 1, in flow diagram form. In the embodiment of FIG. 3, individuals and/or entities can register with the central processing computer 10 and/or with the operator of the central processing computer 10 in order to signify his, her, or its, desire or willingness to receive telemarketing calls or telemarketing messages, and/or to participate in, telemarketing calls, surveys, or polls (hereinafter collectively referred to as “telemarketing call” or telemarketing calls”), in return for compensation or a reward(s).

The individual or entity can register via telephone, on-line via a computer connected to a network, the Internet, and/or the World Wide Web, via mail-in correspondence and/or in any other appropriate manner. The individual can select the types of kinds of telemarketing calls he, she, or it, desires to receive, listen to, and/or in which to participate. The individual or entity can also select the telemarketing calls by compensation provided for same, by time limit, by good, product, or service, type, by telemarketing call times, call days, expected individual participation, and/or by any other criteria.

Information regarding the telemarketing calls, messages, and/or activities, and the compensation for same, can be posted by a telemarketer or telemarketers and can be provided and/or can be made available to the individual or entity from which the respective individual or entity may select and or register for same.

For example, an individual can select to receive telemarketing calls which deal with men's retail products, sporting goods, telephone utility services, which provide cash compensation, discount coupons, and/or rebate coupons, for products of interest to the individual.

In this manner, the individuals or entities can place themselves and their telephone numbers, e-mail addresses, etc., on an “OK to call for compensation list” or other similar type of telemarketing calling list(s). The list can be stored in the database 10I of the central processing computer 10.

With reference to FIG. 3, the operation of the apparatus 100 commences at step 300. At step 301, a telemarketer desiring to make a telemarketing call can select the telemarketing message. At step 302, the telemarketer can identify the individual or entity to whom it desires to make the telemarketing call. The individual or entity and the corresponding individual's or entity's telephone number can be selected from a respective “OK to call for compensation list” or other similar list(s).

At step 303, the telemarketer can place the telephone call to the respective individual or entity (hereinafter, for simplicity, referred to as individual). At step 303, the central processing computer can detect the call being made and detect if the call is answered. At step 303, the telemarketing call or message and be provided to the individual. The telemarketing call or message can be a live message from a telemarketer or a telemarketer's employee or agent or can be a pre-recorded message and/or can be a combination of both.

At step 303, information and/or feedback can also be obtained from the individual. At step 303, in the case of interaction with live person or telemarketer, the person or telemarketer can manually and/or electronically record any information obtained from the individual. In the case of pre-recorded messages, the central processing computer 10 can electronically record the individual's voice responses and/or keypad or touch pad responses to questions or inquiries. In this regard a telemarketing call or message and/or a telemarketing survey of poll can be conducted. Upon the completion of the telemarketing call, the operation of the apparatus 100 will proceed to step 304.

At step 304, the central processing computer 10 can record information regarding the telemarketing call, such as, for example, the length of the call, the amount or portion of the message, live and/or pre-recorded, which was provided to the individual, the outcome of the call (i.e. did the individual listen to the entire call, did the individual listen to only a portion of the call, did the individual make a purchase, participate in a survey or poll, participated in the entire survey or poll, participated in only a portion of the survey, etc.).

The information recorded, at step 304, can be recorded by the central processing computer 10 and/or can be manually entered into the central processing computer 10 by the person or telemarketer's employee who conducted the call, with the information being stored in the database 10I of the central processing computer 10.

Any pre-recorded messages, including messages which can include audio information, video information, and/or text information, can be digitally-marked and/or encoded, and/or time-marked and/or encoded, in order to facilitate how much of the respective information has been provided to, or transmitted to, the individual. Applicant hereby incorporates by reference herein the subject matter and teachings of U.S. patent application Ser. No. 08/788,387, filed Jan. 27, 1997, which teaches an apparatus and method for providing educational materials and/or related services in a network environment. Applicant also hereby incorporates by reference herein the subject matter and teachings of U.S. Pat. No. 5,969,714 which teaches and discloses an interactive video system with frame reference number.

Information regarding the call can be recorded by, and/or can entered into, the central processing computer 10, at any time during and/or after the telemarketing call.

At step 305, the central processing computer 10 will compute the compensation earned by the individual. The compensation calculation can be a fixed amount, can be a pro rata amount based upon the amount of the call the individual listens to, can be determined as a pro rata amount depending upon the individual's degree of participation, and/or via any other manner determined by any one or more of the telemarketers, merchants, advertisers, promoters, account administrators, and/or by the individuals or entities themselves. The compensation provided by the present invention can also be in the form of goods, products, services, and/or subscriptions for goods, products, and/or services.

Once the compensation is calculated and/or determined at step 305, the operation of the central processing computer 10 will proceed to step 306. At step 306, the central processing computer 10 will provide the individual with the individual's earned compensation, or indicia or evidence of the individual's earning of same or becoming the owner of same.

The compensation can be provided to the individual by any one or more of making an accounting entry in the individual's account, by electronically transferring funds to the individual's financial account which can be administered by the central processing computer 10, an account administrators computer 30, and/or a bank of financial institution account associated with the individual, by generating and mailing a check or draft to the individual, by crediting the individual's account with a goods, products, and/or services provider (i.e. electronic gift certificate or account credit), by making payment to a goods, products, and/or services provider, by generating a coupon, a discount coupon, and/or a rebate coupon, and/or by causing such a coupon, a discount coupon, and/or a rebate coupon, to be sent to the individual, and/or by any other appropriate mode or manner, depending upon the compensation and/or reward associated with the telemarketing call, message, and/or activity.

At step 306, the central processing computer can also update the respective telemarketer's account or compensation bank which can be a monetary account, a credit account, a debit account, a coupon inventory, a discount coupon inventory, a rebate coupon inventory, and/or any other account, inventory, and/or entity from which the compensation and/or rewards can be paid.

At step 307, the central processing computer 10 can record and/or store any information regarding the telemarketing call, including time of call, length of call, the amount or portion of the message, live and/or pre-recorded, which was provided to the individual, information obtained, compensation earned, and/or any other information and update files, records, and/or accounts of, or relating to, the involved telemarketer and/or individual. Thereafter, the operation of the apparatus will cease at step 308.

In another preferred embodiment, the compensation and/or reward can be computed, and/or the compensation and/or reward can be provided and/or forwarded to the individual upon completion of the above-described steps.

In another preferred embodiment, the apparatus 100 and method of the present invention can be utilized in order to allow a telemarketer to identify a group or audience of individuals and/or entities to which telemarketing calls can be directed.

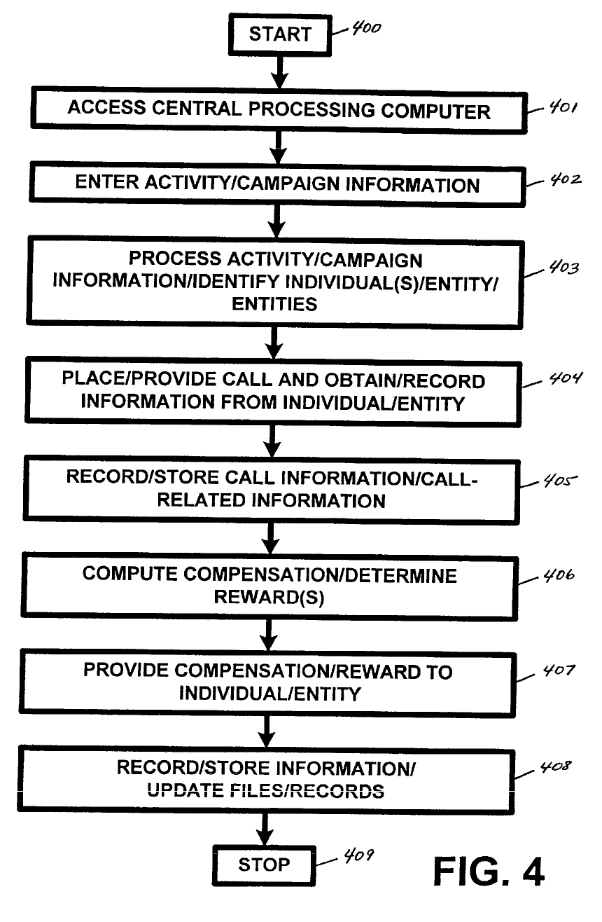

FIG. 4 illustrates another preferred embodiment method for utilizing the apparatus 100 of FIG. 1, in flow diagram form. In the embodiment of FIG. 4, individuals and/or entities can register with the central processing computer 10 and/or with the operator of the central processing computer 10 in order to signify his, her, or its, desire or willingness to receive telemarketing calls or telemarketing messages, and/or to participate in, telemarketing calls, messages, activities, surveys, or polls (hereinafter collectively referred to as “telemarketing call” or telemarketing calls”), in return for compensation or a reward(s).

Individuals or entities can also enter information regarding the kinds and/or amounts of compensation and/or the kinds or types of rewards which they may require or desire for receiving, for listening to, and/or for participating in, respective telemarketing calls, messages, and/or surveys or polls. For example, in addition to and/or instead of selecting to receive, listen to, and/or in which to participate, telemarketing calls or activities, for an offered compensation or reward, an individual can post his or her specifically designated compensation and/or reward requirements (i.e. as so-called “name your own compensation for receiving and listening to a telemarketer's message”).

Any and/or all of the above-described individual or entity entered information can be stored in the database 10I.

As described above, the individual or entity can register via telephone, on-line via a computer connected to a network, the Internet, and/or the World Wide Web, via mail-in correspondence and/or in any other appropriate manner. The individual can select the types of kinds of telemarketing calls he, she, or it, desires to receive, listen to, and/or in which to participate. The individual or entity can also select the telemarketing calls by compensation provided for same, by time limit, by good, product, or service, type, by telemarketing call times, call days, expected individual participation, and/or by any other criteria.

As is also described above, information regarding the telemarketing calls, messages, and/or activities, and the compensation for same, can be posted by a telemarketer or telemarketers and can be provided and/or can be made available to the individual or entity from which the respective individual or entity may select and or register for same.

With reference to FIG. 4, the operation of the apparatus 400 commences at step 400. At step 401, a telemarketer can either access the central processing computer 10 via the telemarketer computer 20 associated therewith and/or by inputting information directly into the central processing computer 10 via the input device 10D.

At step 402, the telemarketer can enter information regarding a telemarketer's activity or campaign. The activity or campaign information can include the telemarketing message or messages to be disseminated and/or the budget for the activity or campaign. The activity or campaign information can also include profile or demographic information which can be provided by the telemarketer which may be characteristic of the audience to which the telemarketing activity or campaign should be directed.

At step 403, the central processing computer 10 can process the telemarketer's telemarketing activity or campaign information in conjunction with the data and/or information stored in the database 10I. At step 403, the central processing computer 10 will identify a target audience of any number of individuals and/or entities from the information stored in the database 10I, from individual and/or entity entered data and/or information concerning the type or kinds of information they desire to receive and the compensation which they have agreed to receive, which may have been compensation offered by the telemarketer and/or in conjunction with a posting of messages, calls, and/or activities, and/or which may specifically requested and/or “named” by the individual or entity.

At step 404, the telemarketer can place the telephone call or telephone calls, depending upon the size of the target audience, to the individual or to each of the individuals and/or entities which have been identified in the target audience.

In the case of multiple individuals or entities, calls can be placed to the individuals or entities simultaneously and/or sequentially. For each call made, at step 404, the central processing computer 10 can detect the call being made and detect if the call is answered. At step 404, the telemarketing call or message and be provided to the respective individual or entity (hereinafter referred to as “individual”). The telemarketing calls or messages can be a live message from a telemarketer or a telemarketer's employee or agent or can be a pre-recorded message and/or can be a combination of both.

At step 404, information and/or feedback can also be obtained from each individual during each call. At step 404, in the case of interaction with live person or telemarketer, the person or telemarketer can manually and/or electronically record any information obtained from the individual. In the case of pre-recorded messages, the central processing computer 10 can electronically record the individual's voice responses and/or keypad or touch pad responses to questions or inquiries. In this regard a telemarketing call or message and/or a telemarketing survey of poll can be conducted. Upon the completion of all of the telemarketing calls or call to the target audience, the operation of the apparatus 100 will proceed to step 405.

At step 405, the central processing computer 10 can record information regarding the telemarketing call or each of the telemarketing calls made at step 404, such as, for example, the length of the call, the amount or portion of the message, live and/or pre-recorded, which was provided to the individual, the outcome of the call (i.e. did each individual listen to the entire call, did each individual listen to only a portion of the call, did each individual make a purchase, participate in a survey or poll, participated in the entire survey or poll, participated in only a portion of the survey, etc.).

The information recorded, at step 405, can be recorded by the central processing computer 10 and/or can be manually entered into the central processing computer 10 by the person or telemarketer's employee who conducted each call, with the information being stored in the database 10I of the central processing computer 10.

Any pre-recorded messages, including messages which can include audio information, video information, and/or text information, can be digitally-marked and/or encoded, and/or time-marked and/or encoded, in order to facilitate how much of the respective information has been provided to, or transmitted to, the individual.

Information regarding each call can be recorded by, and/or can entered into, the central processing computer 10, at any time during and/or after the telemarketing call.

At step 406, the central processing computer 10 will compute the compensation earned by the individual or by each of the individuals or entities of the target audience. For each call, the compensation calculation can be a fixed amount, can be a pro rata amount based upon the amount of the call the respective individual listens to, can be determined as a pro rata amount depending upon the respective individual's degree of participation, and/or via any other manner determined by any one or more of the telemarketers, merchants, advertisers, promoters, account administrators, and/or by the respective individuals or entities themselves.

The compensation provided by the present invention can also be in the form of goods, products, services, and/or subscriptions for goods, products, and/or services.

Once the compensation is calculated and/or determined at step 406, the operation of the central processing computer 10 will proceed to step 407. At step 407, the central processing computer 10 will provide the individual or each of the individual's or entities with their respectively earned compensation, or indicia or evidence of the individual's or each individual's earning of same or becoming the owner of same.

The compensation can be provided to the individual or to each of the individuals or entities by any one or more of making an accounting entry in the respective individual's or entity's account, by electronically transferring funds to the individual's financial account which can be administered by the central processing computer 10, an account administrators computer 30, and/or a bank of financial institution account associated with the individual or each of the individuals or entities, by generating and mailing a check or draft to the individual or each of the individuals or entities, by crediting the individual's or individual's account(s) with a goods, products, and/or services provider (i.e. electronic gift certificate or account credit), by making payment to a goods, products, and/or services provider, by generating a coupon, a discount coupon, and/or a rebate coupon, and/or by causing such a coupon, a discount coupon, and/or a rebate coupon, to be sent to the individual or to each individual or entity, and/or by any other appropriate mode or manner, depending upon the compensation and/or reward associated with the telemarketing call, message, and/or activity.

At step 407, the central processing computer can also update the respective telemarketer's account or compensation bank which can be a monetary account, a credit account, a debit account, a coupon inventory, a discount coupon inventory, rebate coupon inventory, and/or any other account, inventory, and/or entity from which the compensation and/or rewards can be paid.

At step 408, the central processing computer 10 can record and/or store any information regarding the telemarketing call or the telemarketing calls, including time of the call or each call, the length of the call or of each call, information obtained, compensation earned, and/or any other information and update files, records, and/or accounts of, or relating to, the involved telemarketer and/or individual. Thereafter, the operation of the apparatus will cease at step 409.

In another preferred embodiment, telemarketing calls or messages can be recorded and/or stored as voice mail messages for an individual or entity. The individual or entity can access the message or messages and receive same, listen to same, and/or participate in, same. The apparatus 100 and/or the central processing computer 10 can thereafter compute and provide compensation or a reward(s) to the individual or entity.

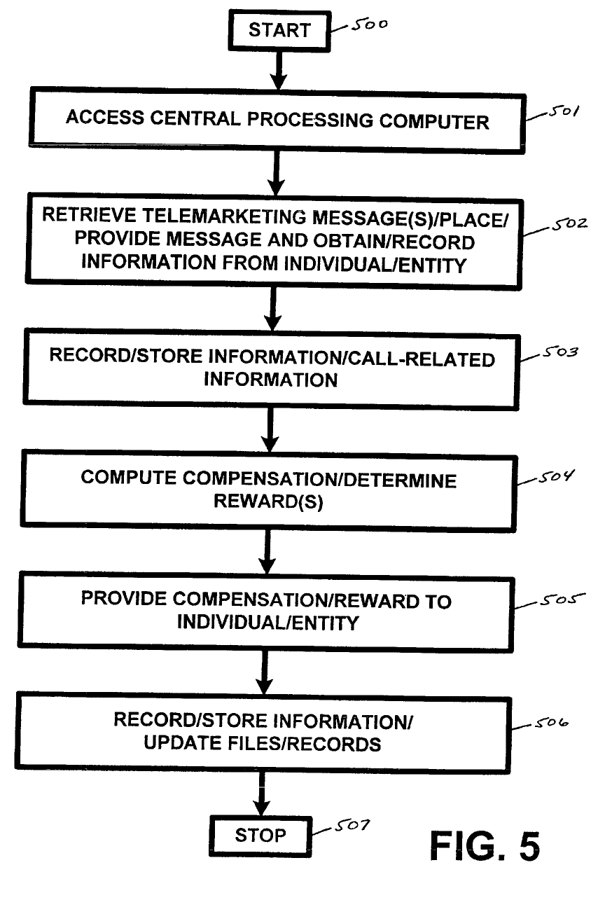

FIG. 5 illustrates another preferred embodiment method for utilizing the apparatus 100 of FIG. 1, in flow diagram form. In the embodiment of FIG. 5, individuals and/or entities can register with the central processing computer 10 and/or with the operator of the central processing computer 10 in order to signify his, her, or its, desire or willingness to receive, to listen to, and/or to participate in, telemarketing messages, surveys or polls, which are or which can be deposited into a voice mailbox which can be assigned to, and/or which can be associated with, the individual or the entity.

The voice mailbox can be stored at, and/or can reside at, the central processing computer 10. The voice mailbox can also be located at any appropriate location or in any appropriate computer, computer system, and/or facility.

The individual or entity can register via telephone, on-line via a computer connected to a network, the Internet, and/or the World Wide Web, via mail-in correspondence and/or in any other appropriate manner. The individual can select the types of kinds of telemarketing calls he, she, or it, desires to receive, to listen to, and/or in which to participate. The individual or entity can also select the telemarketing calls by compensation provided for same, by time limit, by good, product, or service, type, by telemarketing call times, call days, expected individual participation, and/or by any other criteria.

Information regarding the telemarketing calls, messages, and/or activities, and the compensation for same, can be posted by a telemarketer or telemarketers and can be provided and/or can be made available to the individual or entity from which the respective individual or entity may select and or register for same.

For example, an individual can select to receive telemarketing messages which deal with men's retail products, sporting goods, telephone utility services, which provide cash compensation, and/or a coupon, a discount coupon, and/or a rebate coupon, for products of interest to the individual.

In this manner, the individuals or entities can place themselves and their telephone numbers, e-mail addresses, etc., on an “OK to leave message for compensation list” or other similar type of telemarketing calling list(s). The list can be stored in the database 10I of the central processing computer 10.

The telemarketer(s) can, at any time, access the individual's or the entity's voice mailbox and leave a telemarketing message for the individual or entity. The telemarketing message can a recorded from a live message, from a pre-recorder message, and/or from a combination of both.

The central processing computer 10 can keep and/or maintain a record(s) of the telemarketing message(s) recorded or left in the individual's or the entity's voice mailbox as well as store information regarding the telemarketer who or which left the message, the time of the message, the nature of the message (i.e. commercial, advertisement, promotion, survey, poll, etc.), the subject matter of the message (i.e. retail commercial, utility offering, etc.), the compensation provided and/or the reward provided for receiving, listening to, and/or participating in, the message, survey or poll (i.e. cash compensation, amount of compensation, coupon, rebate coupon, etc.), and/or any other information relating to the message or messages stored in the respective voice mailbox.

With reference to FIG. 5, the operation of the apparatus 100 commences at step 500. At step 501, the individual or entity can access the central processing computer via his, her, or its, individual communication device or telephone 40. The individual or entity (hereinafter referred to as “individual”) can access the central processing computer 10 at any time, at the individual's initiative, and/or otherwise.

In another preferred embodiment, the central processing computer 10 can generate a recorded voice message, an e-mail message, an instant messaging message, a short message, beeper message, pager message, and/or any other electronic message or electronic transmission, and transmit same to the individual, and/or to any respective telephone, telephone answering machine, computer, personal digital assistant, beeper, pager, and/or other individual communication device 40, so as to provide notification to the individual that telemarketing messages have been left at, and/or stored in, his or her voice mailbox.

At step 502, the individual can retrieve his or her telemarketing message or messages, one at a time, if applicable. For each telemarketing message retrieved, at step 502, the central processing computer 10 can detect the individual's accessing of the message and the message being played for the individual. At step 502, the telemarketing message and be provided to the respective individual in its entirety and/or for as long as the individual desires to receive, to listen to, and/or to participate in, same.

At step 502, information and/or feedback can also be obtained from individual during the playing or transmission of each message. At step 502, the central processing computer 10 can record and/or store any information, voice responses, electronically input responses, such as keypad or touch pad entries or responses, which are provided by, and/or received from, the individual during the course of the message and/or after the message has been played. The central processing computer 10 can electronically record the individual's voice responses and/or keypad or touch pad responses to questions or inquiries. In this regard a telemarketing call or message and/or a telemarketing survey of poll can be conducted.

Upon the completion of the playing of the telemarketing message, the operation of the apparatus 100 will proceed to step 503.

At step 503, the central processing computer 10 can, for each message, record information regarding the telemarketing message, such as, for example, the length of the message, the amount or portion of the message which was provided to the individual, the outcome of the message (i.e. did the individual listen to the entire message, did the individual listen to only a portion of the message, did the individual make a purchase, participate in a survey or poll, participated in the entire survey or poll, participated in only a portion of the survey, etc.). The information recorded, at step 503, can be recorded by, and stored in, the central processing computer 10, with the information being stored in the database 10I of the central processing computer 10.

Any of the messages described herein can include audio information, video information, and/or text information. The information can be digitally-marked and/or encoded, and/or time-marked and/or encoded, in order to facilitate how much of the respective information has been provided to, or transmitted to, the individual.

Information regarding the message can be recorded by, and/or can entered into, the central processing computer 10, at any time during and/or after the playing of the telemarketing message.

At step 504, the central processing computer 10 will compute the compensation earned by the individual. The compensation calculation can be a fixed amount, can be a pro rata amount based upon the amount of the message the individual listens to, can be determined as a pro rata amount depending upon the individual's degree of participation, and/or via any other manner determined by any one or more of the telemarketers, merchants, advertisers, promoters, account administrators, and/or by the individuals or entities themselves. The compensation provided by the present invention can also be in the form of goods, products, services, and/or subscriptions for goods, products, and/or services.

Once the compensation is calculated and/or determined at step 504, the operation of the central processing computer 10 will proceed to step 505. At step 505, the central processing computer 10 will provide the individual with the individual's earned compensation, or indicia or evidence of the individual's earning of same or becoming the owner of same.

The compensation can be provided to the individual by any one or more of making an accounting entry in the individual's account, by electronically transferring funds to the individual's financial account which can be administered by the central processing computer 10, an account administrators computer 30, and/or a bank of financial institution account associated with the individual, by generating and mailing a check or draft to the individual, by crediting the individual's account with a goods, products, and/or services provider (i.e. electronic gift certificate or account credit), by making payment to a goods, products, and/or services provider, by generating a coupon, a discount coupon and/or a rebate coupon, and/or by causing such a coupon, a discount coupon and/or a rebate coupon, to be sent to the individual, and/or by any other appropriate mode or manner, depending upon the compensation and/or reward associated with the telemarketing message and/or activity.

At step 505, the central processing computer 10 can also update the respective telemarketer's account or compensation bank which can be a monetary account, a credit account, a debit account, a coupon inventory, a discount coupon inventory, rebate coupon inventory, and/or any other account, inventory, and/or entity from which the compensation and/or rewards can be paid.

At step 506, the central processing computer 10 can record and/or store any information regarding the telemarketing message, including time of message retrieval, length of message, the amount or portion of the message, which was provided to the individual, information obtained, compensation earned, and/or any other information and update files, records, and/or accounts of, or relating to, the involved telemarketer and/or individual.

The above-described process of steps 502 through 506 can thereafter be repeated for any other message or messages stored in the individual's voice mailbox.

Thereafter, the operation of the apparatus will cease at step 507.

In any and/or all of the embodiments described herein, the apparatus 100 and/or the central processing computer 10 can be programmed in order to provide notification, via any appropriate call, message, and/or transmission, to any of the herein-described individuals and/or entities, of the existence of and/or of the availability of a telemarketing call, telemarketing calls, a telemarketing message, telemarketing messages, and/or a telemarketing activity or telemarketing activities, for which compensation and/or a reward is being offered. Thereafter, the respective individuals or entities can register to receive, to listen to, and/or to participate in, the respective telemarketing call, telemarketing calls, a telemarketing message, telemarketing messages, and/or a telemarketing activity or telemarketing activities.

In any and/or all of the embodiments described herein, the apparatus 100 and/or the central processing computer 10 can also be programmed in order to provide notification, via any appropriate call, message, and/or transmission, to any of the herein-described telemarketers, merchants, vendors, providers, advertisers, and/or promoters, of the existence of and/or of the willingness of individuals or entities to receive, to listen to, and/or to participate in, a telemarketing call, telemarketing calls, a telemarketing message, telemarketing messages, and/or a telemarketing activity or telemarketing activities, for which compensation and/or a reward is being offered. Thereafter, the respective telemarketers can offer and/or provide the respective telemarketing call, telemarketing calls, a telemarketing message, telemarketing messages, and/or a telemarketing activity or telemarketing activities, to the respective individual, individuals, entity, or entities.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of any of the respective individuals, entities, telemarketers, merchants, vendors, providers, advertisers, and/or promoters, described herein as utilizing the apparatus 100 of the present invention, so as to act on behalf of the respective individual(s), entity, entities, telemarketer, telemarketers, merchant, merchants, vendor, vendors, provider, providers, advertiser, advertisers, promoter, and/or promoters, as well as to perform any of processing functions and/or other functions described herein.

The intelligent agent can act on behalf of the respective individual(s), entity, entities, telemarketer, telemarketers, merchant, merchants, vendor, vendors, provider, providers, advertiser, advertisers, promoter, and/or promoters, in various related interactions and/or other activities which are described as being performed herein and/or which may be incidental and/or related thereto. Therefore, the present invention also provides an agent-based apparatus and method for providing compensation based telemarketing calls, messages, and/or activities.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

In any and/or all of the embodiments described herein, the apparatus 100 and/or the central processing computer 10 can administer and/or maintain a financial account(s) for, or on behalf of, any of the herein-described and/or herein-defined individuals, entities, telemarketers, merchants, vendors, providers, advertisers, and/or promoters, who or which utilize the apparatus and method of the present invention. The financial accounts may be bank accounts, electronic money accounts, credit accounts, debit account, charge accounts, and/or any other accounts for facilitating financial transactions.

The apparatus 100 and/or the central processing computer 10 can make a payment and/or a transfer for, or on behalf of, any of the herein-described and/or herein-defined individuals, entities, telemarketers, merchants, vendors, providers, advertisers, and/or promoters, and/or can receive a payment and/or a transfer for, or on behalf of, any of the herein-described and/or herein-defined individuals, entities, telemarketers, merchants, vendors, providers, advertisers, and/or promoters, whichever the case may be.

The apparatus and method of the present invention can provide an apparatus, a system, and/or a platform, for providing compensation-based telemarketing calls, messages, and/or activities which can provide an incentive for individuals or entities to receive, to listen to, and/or to participate in, telemarketing calls, messages, surveys, polls, and/or other activities.

The apparatus and method of the present invention can also provide an apparatus, a system, and/or a platform, for providing compensation-based telemarketing calls, messages, and/or activities, which can enable respective telemarketers, merchants, vendors, providers, advertisers, and/or promoters, to more efficiently and/or more effectively target and/or disseminate their respective telemarketing calls, messages, and/or activities, to individuals, entities, and/or audiences of individuals or entities. The apparatus and method of the present invention can also facilitate the dissemination of telemarketing calls, messages, and/or activities, and/or surveys or polls, to willing and/or cooperative individuals or entities.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus for providing compensation-based telemarketing information, comprising:
a memory device for storing at least one of individual information for at least one individual, individual telephone number information for at least one individual, telemarketer information, compensation information, reward information, telemarketing call information, telemarketing message information, telemarketing subject matter, telemarketing activity information, survey information, survey subject matter, polling information, and polling subject matter;
a processor, wherein the processor detects at least one of a telemarketing call being made to an individual, a telemarketing message being provided to an individual, telemarketing activity, a survey being performed, and a poll being taken, wherein the processor records information regarding at least one of information provided to the individual, information obtained from the individual, and information regarding at least one of a telemarketing call, telemarketing message, telemarketing activity, survey, and poll, and further wherein the processor at least one of calculates a compensation earned by the individual and determines a reward earned by the individual as compensation for the individual at least one of receiving, listening to, and participating in, the at least one of a telemarketing call, telemarketing message, telemarketing activity, survey, and poll, and further wherein the processor stores information regarding at least one of compensation and a reward earned by the individual; and
at least one of an output device for outputting information regarding the at least one of compensation and a reward earned by the individual, and a transmitter for transmitting information regarding the at least one of compensation and a reward earned by the individual to a communication device associated with the individual.

2. The apparatus of claim 1, wherein the at least one of compensation and a reward earned by the individual is at least one of cash compensation, monetary compensation, non-cash compensation, non-monetary compensation, a coupon, a discount coupon, a rebate, a rebate coupon, a special offering, a good, a product, a service, and a subscription.

3. The apparatus of claim 1, wherein the processor updates information stored in the memory device subsequent to providing the at least one of a telemarketing call, telemarketing message, telemarketing activity, survey, and poll, to the individual.

4. The apparatus of claim 1, further comprising:
a receiver for receiving information regarding at least one of a telemarketing call, a telemarketing message, telemarketing activity, a survey, and a poll, which an individual at least one of desires to receive, to listen to, and in which to participate.

5. The apparatus of claim 1, wherein the memory device contains information regarding at least one of a telemarketing call, a telemarketing message, telemarketing activity, a survey, and a poll, which the individual at least one of desires to receive, to listen to, and in which to participate.

6. The apparatus of claim 1, wherein the communication device associated with the individual is at least one of a telephone, a computer, a personal digital assistant, a wireless telephone, a watch, a telephone answering machine, a voice mailbox, a personal computer, a video telephone, a wireless device, a handheld device, a palm-top device, and a personal communication device.

7. The apparatus of claim 1, wherein the transmitter transmits information regarding at least one of compensation and a reward being offered for at least one of receiving, listening to, and participating in, at least one of a telemarketing call, a telemarketing message, telemarketing activity, a survey, and a poll.

8. The apparatus of claim 1, wherein the processor generates a message containing information regarding an individual who is willing to at least one of receive, listen to, and participate in, at least one of a telemarketing call, a telemarketing message, telemarketing activity, a survey, and a poll, and further wherein the transmitter transmits the message to a communication device associated with a telemarketer.

9. The apparatus of claim 1, wherein the processor generates a message containing information regarding at least one of a telemarketing call, a telemarketing message, telemarketing activity, a survey, and a poll, for which at least one of compensation and a reward is being offered, and further wherein the transmitter transmits the message to a communication device associated with an individual.

10. The apparatus of claim 1, wherein the at least one of a telemarketing call being made to an individual, a telemarketing message being provided to an individual, telemarketing activity, a survey being performed, and a poll being taken, contains at least one of live information, pre-recorded information, and a combination of live information and pre-recorded information.

11. An apparatus for providing compensation-based telemarketing information, comprising:
a memory device for storing at least one of individual information for a plurality of individuals, individual telephone number information for a plurality of individuals, telemarketer information, compensation information, reward information, telemarketing call information, telemarketing message information, telemarketing subject matter, telemarketing activity information, survey information, survey subject matter, polling information, and polling subject matter;
a processor, wherein the processor processes a request to identity an audience containing at least one individual, wherein the processor generates an audience list in response to the request, and further wherein the processor detects at least one of a telemarketing call being made to an individual, a telemarketing message being provided to an individual, telemarketing activity, a survey being performed, and a poll being taken, involving at least one individual identified in the audience, and further wherein the processor records information regarding at least one of information provided to the individual, information obtained from the individual, and information regarding at least one of a telemarketing call, telemarketing message, telemarketing activity, survey, and poll, and further wherein the processor at least one of calculates a compensation earned by the individual and determines a reward earned by the individual as compensation for the individual at least one of receiving, listening to, and participating in, the at least one of a telemarketing call, telemarketing message, telemarketing activity, survey, and poll, and further wherein the processor stores information regarding at least one of compensation and a reward earned by the individual; and
at least one of an output device for outputting information regarding the at least one of compensation and a reward earned by the individual, and a transmitter for transmitting information regarding the at least one of compensation and a reward earned by the individual to a communication device associated with the individual.

12. The apparatus of claim 11, wherein the at least one of compensation and a reward earned by the individual is at least one of cash compensation, monetary compensation, non-cash compensation, non-monetary compensation, a coupon, a discount coupon, a rebate, a rebate coupon, a special offering, a good, a product, a service, and a subscription.

13. The apparatus of claim 11, wherein the memory device contains information regarding at least one of a telemarketing call, a telemarketing message, telemarketing activity, a survey, and a poll, which the individual at least one of desires to receive, to listen to, and in which to participate, and further wherein the processor updates information stored in the memory device subsequent to providing the at least one of a telemarketing call, telemarketing message, telemarketing activity, survey, and poll, to the individual.

14. The apparatus of claim 11, further comprising:
a receiver for receiving information regarding at least one of a telemarketing call, a telemarketing message, telemarketing activity, a survey, and a poll, which an individual at least one of desires to receive, to listen to, and in which to participate.

15. The apparatus of claim 11, wherein the transmitter transmits information regarding at least one of compensation and a reward being offered for at least one of receiving, listening to, and participating in, at least one of a telemarketing call, a telemarketing message, telemarketing activity, a survey, and a poll.

16. The apparatus of claim 11, wherein the processor generates a message containing information regarding an individual who is willing to at least one of receive, listen to, and participate in, at least one of a telemarketing call, a telemarketing message, telemarketing activity, a survey, and a poll, and further wherein the transmitter transmits the message to a communication device associated with a telemarketer.

17. The apparatus of claim 11, wherein the processor generates a message containing information regarding at least one of a telemarketing call, a telemarketing message, telemarketing activity, a survey, and a poll, for which at least one of compensation and a reward is being offered, and further wherein the transmitter transmits the message to a communication device associated with an individual.

18. The apparatus of claim 11, wherein the processor identifies the audience of at least one individual from at least one of individual provided information, individual past behavior information, profile information, and demographic information, and wherein the at least one of a telemarketing call being made to an individual, a telemarketing message being provided to an individual, telemarketing activity, a survey being performed, and a poll being taken, contains at least one of live information, pre-recorded information, and a combination of live information and pre-recorded information.

19. An apparatus for providing compensation-based telemarketing information, comprising:
a memory device for storing at least one of individual information for at least one individual, individual telephone number information for at least one individual, telemarketer information, compensation information, reward information, telemarketing call information, telemarketing message information, telemarketing subject matter, telemarketing activity information, survey information, survey subject matter, polling information, polling subject matter, and at least one telemarketing message for an individual;
a receiver for receiving a request by an individual to retrieve at least one telemarketing message stored in the memory device;
a processor, wherein the processor processes the retrieval request and provides the at least one stored telemarketing message to the individual, and further wherein the processor detects the at least one telemarketing message being provided to the individual, wherein the processor records information regarding at least one of information provided to the individual, information obtained from the individual, and information regarding at least one of a telemarketing message, telemarketing activity, survey, and poll, and further wherein the processor at least one of calculates a compensation earned by the individual and determines a reward earned by the individual as compensation for the individual at least one of receiving, listening to, and participating in, the telemarketing message, and further wherein the processor stores information regarding at least one of compensation and a reward earned by the individual; and
at least one of an output device for outputting information regarding the at least one of compensation and a reward earned by the individual, and a transmitter for transmitting information regarding the at least one of compensation and a reward earned by the individual to a communication device associated with the individual.

20. The apparatus of claim 19, wherein the receiver receives information regarding at least one telemarketing message which an individual at least one of desires to receive, to listen to, and in which to participate, and further wherein the transmitter transmits the message to a communication device associated with an individual.
